(19) United States
(12) Patent Application Publication
(10) Pub. No.: US 2014/0357534 A1
(43) Pub. Date: Dec. 4, 2014

(54) METHODS, APPARATUS, AND SENSORS FOR TRACING FRAC FLUIDS IN MINERAL FORMATIONS, PRODUCTION WATERS, AND THE ENVIRONMENT USING MAGNETIC PARTICLES

(71) Applicants: WILLIAM MARSH RICE UNIVERSITY, Houston, TX (US); UNIVERSITY OF ALBERTA, Edmonton (CA)

(72) Inventors: Andrew Ross Barron, Houston, TX (US); David Keith Potter, Edmonton (CA); Samuel J. Maguire-Boyle, Houston, TX (US); Emil Pena, Pearland, TX (US); Lauren Morrow, Houston, TX (US)

(73) Assignees: William Marsh Rice University, Houston, TX (US); University of Alberta, Edmonton, AB (CA)

(21) Appl. No.: 14/363,851

(22) PCT Filed: Dec. 10, 2012
(86) PCT No.: PCT/US12/68738

§ 371 Date: Jun. 9, 2014

Related U.S. Application Data
(60) Provisional application No. 61/569,037, filed on Dec. 9, 2011.

(51) Int. Cl. E21B 47/10; G01N 27/72; C09K 8/62; C09K 8/05; H01F 1/01; C01G 49/00

(52) U.S. Cl. CPC E21B 47/1015; H01F 1/01; C01G 49/0072; C09K 8/62; C09K 8/05; G01N 27/72; C01P 2006/42
USPC 507/140; 166/250.12; 252/62.62; 507/272; 507/271; 507/270; 324/201

(57) ABSTRACT

In some embodiments, the present invention pertains to methods of detecting a contamination of an environment by a fracture fluid that comprises magnetic particles. In some embodiments, such methods include: (1) collecting a sample from the environment; and (2) measuring a magnetic susceptibility of the sample in order to detect the presence or absence of the magnetic particles. Further embodiments of the present invention pertain to methods of tracing fracture fluids in a mineral formation. In some embodiments, such methods include: (1) associating the fracture fluids with magnetic particles; (2) introducing the fracture fluids into the mineral formation; and (3) measuring a magnetic susceptibility of the fracture fluids. Additional embodiments of the present invention pertain to fracture fluids containing the aforementioned magnetic particles, the actual magnetic particles, and methods of making said magnetic particles.

### CROSS-REFERENCE TO RELATED APPLICATIONS

This application claims priority to U.S. Provisional Patent Application No. 61/569,037, filed on Dec. 9, 2011. The entirety of the aforementioned application is incorporated herein by reference.

### BACKGROUND

Currently, there is significant publicity relating to the potential for contamination of various environments by fracture fluids. In addition, a need exists for methods of identifying and tracing fracture fluids in various environments and mineral formations. The present disclosure addresses the aforementioned needs.

### BRIEF SUMMARY

In some embodiments, the present disclosure pertains to methods of detecting a contamination of an environment by a fracture fluid containing magnetic particles. In some embodiments, such methods include: (1) collecting a sample from the environment; and (2) measuring a magnetic susceptibility of the sample in order to detect the presence or absence of the magnetic particles. In some embodiments, the presence of the magnetic particles indicates the presence of the fracture fluid in the environment. In some embodiments, the magnetic susceptibility of the sample is used to identify the source of the contaminating fracturing fluid. In some embodiments, the source of the contaminating fracturing fluid is identified by comparing a magnetic hysteresis curve of the sample with the magnetic hysteresis curves of known magnetic particles. In some embodiments, the magnetic susceptibility of the magnetic particles may be measured in a temperature dependent manner. In some embodiments, the aforementioned methods may also include a step of measuring the Curie temperature of the magnetic particles in the sample in order to identify the source of the fracturing fluid.

In some embodiments, the magnetic particles may include MₓM′_{y}Fe₂O₄. In some embodiments, x+y=1. In some embodiments, M and M′ are each selected from the group consisting of zinc, manganese, cobalt, copper, vanadium, and combinations thereof. In some embodiments, the molar ratio of x to y is at least one of 0.5:0.5, 0.35:0.65, 0.65:0.35, 0.4:0.6, 0.6:0.4, 0.1:0.90, or 0.9:0.1. In some embodiments, the magnetic particles comprise MnₓZn_{y}Fe₂O₄, as described above. In some embodiments the magnetic particles comprise Mn_{0.5}Zn_{0.5}Fe₂O₄. In some embodiments, the magnetic particles exclude Fe₃O₄. In some embodiments, the magnetic particles of the present disclosure can have sizes that range from about 0.1 nm to about 1000 nm, from about 0.5 nm to about 200 nm, or from about 10 nm to about 30 nm.

Additional embodiments of the present disclosure pertain to methods of tracing fracture fluids in a mineral formation. In some embodiments, the methods comprise: (1) associating the fracture fluids with magnetic particles; (2) introducing the fracture fluids into the mineral formation; and (3) measuring a magnetic susceptibility of the magnetic particles in the fracture fluids. In some embodiments, the measuring step may occur while the fracture fluids are still in the mineral formation. In some embodiments, the measuring step may occur after a sample of the fracture fluids is collected from the mineral formation. In some embodiments, the measuring step may occur while the fluids flow out of or escape from the mineral formation. In some embodiments, the mineral formation comprises a reservoir, such as a borehole. In some embodiments, the aforementioned methods may also include a step of measuring the Curie temperature of the magnetic particles in the fracture fluid.

In some embodiments, the fracture fluids containing the magnetic particles may include at least one of water (e.g., production water or flood water), proppant, brine, drilling fluid, drilling mud, hydrocarbons, hydraulic fluids, and combinations thereof. In some embodiments, the fracture fluids comprise proppant.

Further embodiments of the present disclosure pertain to methods of tracing production water. In some embodiments, such methods comprise: (1) associating a fracture fluid (e.g., drilling fluid or water flood) with magnetic particles; (2) introducing the fracture fluid (e.g., drilling fluid or water flood) into the mineral formation; and (3) measuring a magnetic susceptibility of magnetic particles in the produced water that is recovered from the mineral formation. In some embodiments, the measuring step may occur while the fluids escape from the mineral formation into the ground water.

Additional embodiments of the present disclosure pertain to fracture fluids containing the aforementioned magnetic particles. Further embodiments of the present disclosure pertain to the actual magnetic particles and methods of making them.

### BRIEF DESCRIPTION OF THE FIGURES

FIG. 1 is a scheme of a method for detecting the contamination of an environment by fracture fluids.

FIG. 2 is a scheme of a method for tracing fracture fluids in mineral formations.

FIG. 3 is a schematic representation of a functionalized magnetic particle.

FIG. 4 is an image of a variable field translation balance (VFTB) for determining magnetic hysteresis curves at various temperatures.

FIG. 5 shows magnetic hysteresis measurements of spinel ferrite P37 at various temperatures.

FIG. 6 shows magnetic hysteresis measurements of spinel ferrite P36 at various temperatures.

FIG. 7 shows magnetic hysteresis measurements of spinel ferrite P42 at various temperatures.

FIG. 8 is a bench-top scaled version of a Molecular Filtration unit that can be used to make magnetic particles.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

In order to maximize the recovery of oil and gas from subterranean formations or reservoirs, it is desirable to maximize the flow characteristics or porosity of the rock within the reservoir. In order to create sufficient flow and recovery of hydrocarbons, the porosity of the reservoir is often increased by hydraulic fracturing.

Hydraulic fracturing is a stimulation treatment routinely performed on oil and gas wells in low-permeability reservoirs. Specially engineered fluids are pumped at high pressure and rate into the reservoir interval to be treated, causing a vertical fracture to open. The wings of the fracture extend away from the wellbore in opposing directions according to the natural stresses within the formation. For instance, a proppant, such as grains of sand of a particular size, is mixed with the treatment fluid to keep the fracture open when the treatment is complete.

Advantageously, hydraulic fracturing creates high-conductivity communication with a large area of formation and bypass any damage that may exist in the near-wellbore area. However, there has been increasing concern over the potential environmental hazards associated with hydraulic fracturing. In particular, there is concern that hydraulic fracturing extends into regions of the formation that contain water, thereby resulting in contamination of ground or well water with hydrocarbons, such as natural gas. There is further concern that the fluids used in the hydraulic fracture can contaminate ground or well water. As such, there is a need for non-hazardous tracer materials that enable the determination of such potential contamination.

The low porosity and permeability of many oil and gas reservoirs even after hydraulic fracturing means that any tracer material must have a size sufficiently small to allow for its transport through the rock formation. Accordingly, magnetic nanoparticles represent a potential tracer material. Furthermore, the special electrical and magnetic properties of nanomaterials make them well suited for use as injected tracer agents.

However, there are several issues with the concept of detecting a magnetic tracer that is originally placed within a hydraulic fracture, but has migrated to other regions of the reservoir. The first issue is that many rock formations are themselves magnetic. As a consequence, well or ground water may naturally contain particles of dissolved solids from these rocks. In particular, ferrimagnetic oxides (such as magnetite) are strongly magnetic. Even some paramagnetic reservoir minerals (e.g., siderite, ilmenite, chamosite, leppidocrocite, and chlorite) are significantly more magnetic than the main matrix minerals, such as quartz (in clastic reservoirs) calcite, or dolomite (in carbonate reservoirs). Therefore, the detection of a magnetic field would not differentiate between the tracer and the natural rock materials.

A second issue is that, in order to detect the magnetic field of a particle in the presence of a magnetic rock, sufficient concentration of the particles must be used during the detection process. Magnetic susceptibility measurements provide a method of characterizing magnetic materials, but are not currently routinely performed in the petroleum industry, either in water analysis laboratories, core analysis laboratories, or downhole, such as in wireline logging measurements while drilling (MWD), or logging while drilling (LWD) operations.

As such, a need exists for novel and improved methods of identifying and tracing fracture fluids in various environments and mineral formations. Various embodiments of the present disclosure address the aforementioned needs.

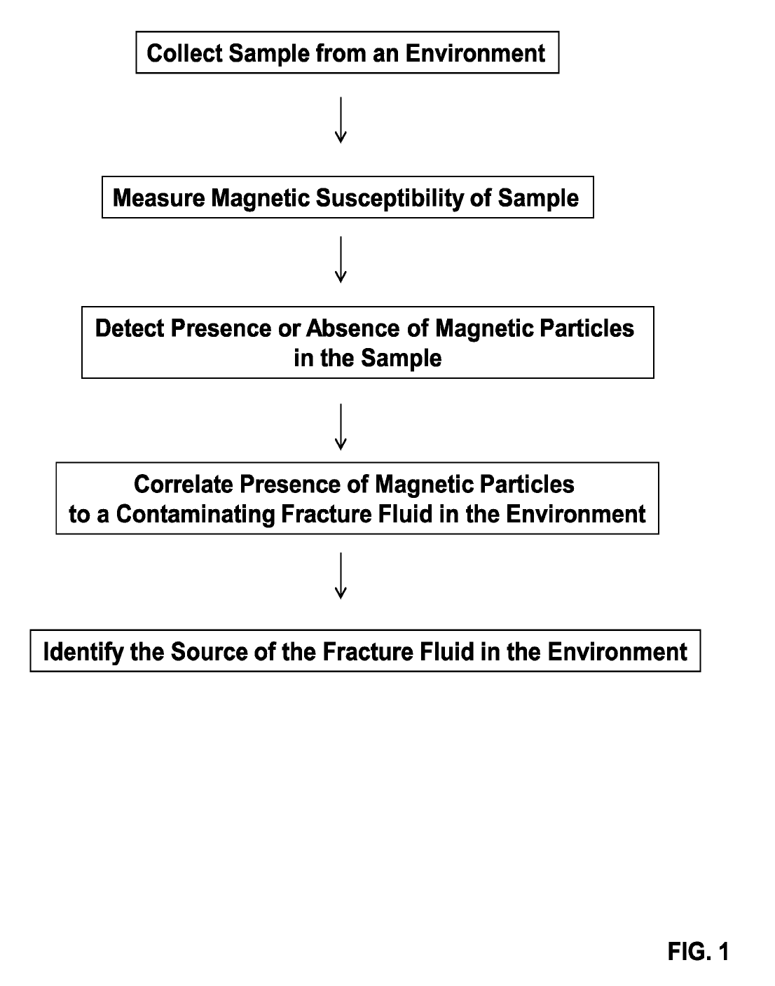

For instance, in some embodiments that are illustrated in FIG. 1, the present disclosure provides methods of detecting a contamination of an environment by a fracture fluid that contains magnetic particles. In some embodiments, such methods include: (1) collecting a sample from the environment that is suspected of being contaminated by a fracture fluid; and (2) measuring a magnetic susceptibility of the sample in order to detect the presence or absence of magnetic particles. In such embodiments, the presence of the magnetic particles can indicate the presence of the fracture fluid in the environment.

In some embodiments, the present disclosure provides methods of detecting a contamination of an environment by produced water that contains magnetic particles. In some embodiments, such methods include: (1) collecting a sample from the environment that is suspected of being contaminated by a produced water; and (2) measuring a magnetic susceptibility of the sample in order to detect the presence or absence of magnetic particles. In such embodiments, the presence of the magnetic particles can indicate the presence of the produced water in the environment.

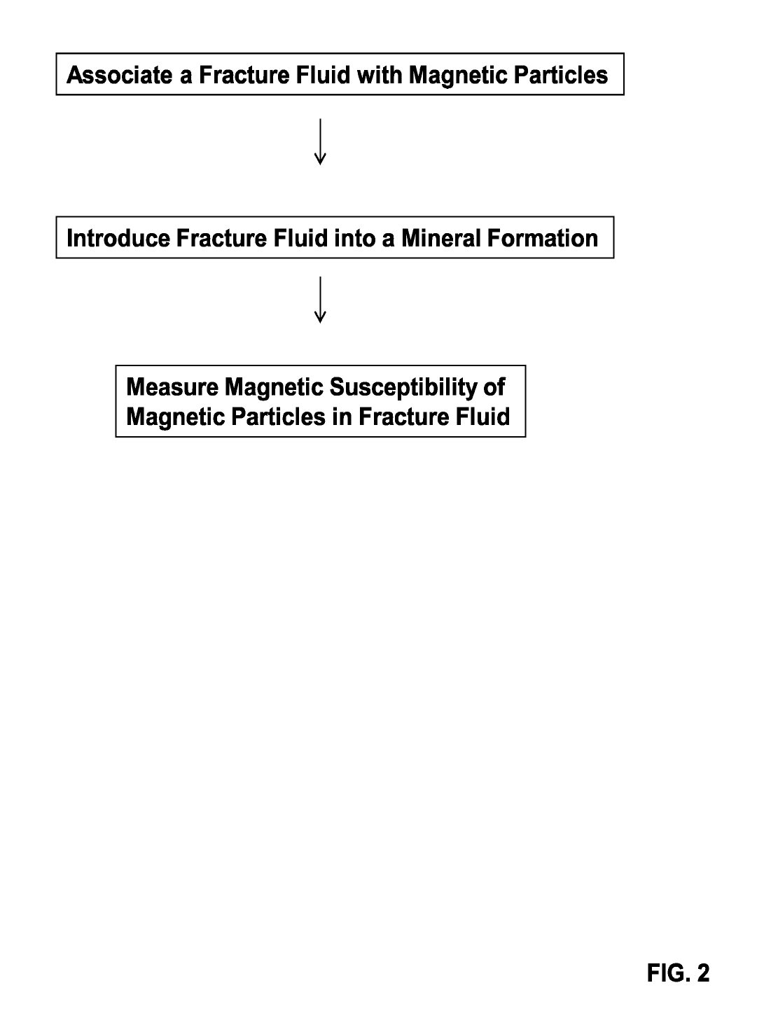

In additional embodiments that are illustrated in FIG. 2, the present disclosure provides methods of tracing fracture fluids in mineral formations. In some embodiments, such methods include: (1) associating the fracture fluids with magnetic particles; (2) introducing the fracture fluids into the mineral formation; and (3) measuring a magnetic susceptibility of the magnetic particles in the fracture fluids.

Further embodiments of the present disclosure pertain to fracture fluids that contain magnetic particles that can be traced through mineral formations or detected in various environments. Additional embodiments of the present disclosure pertain to the actual magnetic particles and methods of making them. More detailed aspects of the aforementioned embodiments will now be discussed herein as non-limiting examples.

Magnetic Particles

Magnetic particles generally refer to particles that display magnetic properties. In some embodiments, such magnetic particles may be associated with fracturing fluids and used to identify the source of the fracturing fluid. See, e.g., FIG. 1. In some embodiments, such magnetic particles may be used to trace the flow of the fracturing fluid in various mineral formations. See, e.g., FIG. 2.

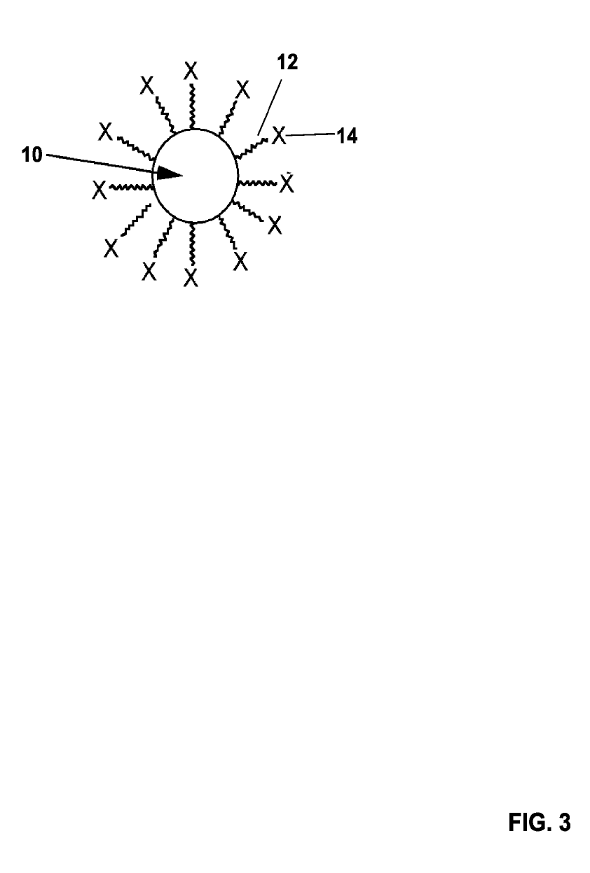

An example of a magnetic particle is shown in FIG. 3 as magnetic nanoparticle 10 with surface substituents 12 and functional groups 14. As set forth in more detail herein, various magnetic particles may be utilized in the embodiments of the present disclosure.

In some embodiments, magnetic particles may be chosen for their stability to down-hole conditions, their miscibility with one or more desired solvents, or their magnetic susceptibility, such as temperature dependent magnetic susceptibility or low field magnetic susceptibility. In more specific embodiments, magnetic particles may be chosen for their compatibility with typical conditions (e.g., pH and salinity) as well as their compatibility with typical fluids used during fracing (e.g., guar gum). In some embodiments, magnetic nanoparticles may be chosen based on size and magnetism required to allow for their concentration and separation from large volumes of fluids, such as water.

In some embodiments, the magnetic particles of the present disclosure may have limited reactivity with species encountered within various environments and mineral formations, such as downhole environments. For instance, in some embodiments, the magnetic particles may be non-biodegradable. In some embodiments, the magnetic particles of the present disclosure may be non-reactive towards sulfur containing compounds, such as hydrogen sulfide. In more specific embodiments, the magnetic particles can be designed to be stable to hydrogen sulfide and bacteriological degradation.

In some embodiments, the magnetic particles of the present disclosure exclude ferrite particles (i.e., Fe₃O₄). In various embodiments, such ferrite particles may have various disadvantages. For instance, the magnetic susceptibility of many ferrite particles is low. Likewise, ferrite particles may react readily with hydrogen sulfide, which alters their magnetic susceptibility.

In some embodiments, the magnetic particles of the present disclosure include the following formula: MₓM′_{y}Fe₂O₄. In some embodiments, x+y=1. In some embodiments, M and M′ are each selected from the group consisting of zinc, manganese, cobalt, copper, vanadium, and combinations thereof. In some embodiments, the molar ratio of x to y is at least one of 0.5:0.5, 0.35:0.65, 0.65:0.35, 0.4:0.6, 0.6:0.4, 0.1:0.90, or 0.9:0.1.

In some embodiments, the magnetic particles of the present disclosure include the following formula: MnₓZn_{y}Fe₂O₄. In some embodiments, x+y=1. In some embodiments, the molar ratio of x to y is at least one of 0.5:0.5, 0.35:0.65, 0.65:0.35, 0.4:0.6, 0.6:0.4, 0.1:0.90, or 0.9:0.1. In some embodiments, the magnetic particles of the present disclosure may include Mn_{0.5}Zn_{0.5}Fe₂O₄.

In some embodiments, the magnetic particles of the present disclosure may be functionalized with one or more functional groups. In some embodiments, the functionalization of magnetic particles can facilitate transport through a particular rock or mineral formation within a subterranean reservoir. In some, the functionalization of magnetic particles can allow for their miscibility or solubility in various solvents, such as water, saline (brine) solution, or hydrocarbons. In some embodiments, the functional groups may include at least one of carboxyl groups, sulfur groups, amine groups, hydroxyl groups, and combinations thereof.

In more specific embodiments, water solubility of magnetic particles can be attained through the use of substituents that promote hydrogen bonding. See, e.g., R. L. Callender, C. J. Harlan, N. M. Shapiro, C. D. Jones, D. L. Callahan, M. R. Wiesner, R. Cook, and A. R. Barron, Aqueous synthesis of water soluble alumoxanes: environmentally benign precursors to alumina and aluminum-based ceramics, Chem. Mater., 1997, 9, 2418. Also see C. D. Jones, A. R. Barron, M. R. Wiesner, and J.-Y. Bottero, Synthesis and characterization of carboxylate-FeOOH particles (ferroxanes) and ferroxane-derived ceramics, J. Rose, M. M. Cortalezzi-Fidalgo, S. Moustier, C. Magnetto, Chem. Mater., 2002, 14, 621. Additional charged substituents can also be used. See, e.g., L. Zeng, L. Zhang, and A. R. Barron, Tailoring aqueous solubility of functionalized single-wall carbon nanotubes over a wide pH range through substituent chain length. Nano Lett., 2005, 5, 2001.

In other embodiments, solubility of magnetic particles in organic solvents can be attained through the use of hydrophobic substituents. See, e.g., C. C. Landry, N. Pappè, M. R. Mason, A. W. Apblett, A. N. Tyler, A. N. MacInnes, and A. R. Barron, From minerals to materials: synthesis of alumoxanes from the reaction of boehmite with carboxylic acids. J. Mater. Chem., 1995, 5, 331). Thus, the solubility of desired magnetic particles can be readily controlled through the choice of surface functional groups.

The magnetic particles of the present disclosure can also have various sizes. In some embodiments, the magnetic particles of the present disclosure may include magnetic nanoparticles. In some embodiments, the magnetic nanoparticles can have sizes that range from about 0.1 nm to about 1000 nm. In some embodiments, the magnetic nanoparticles can have sizes that range from about 0.5 nm to about 200 nm. In some embodiments, magnetic nanoparticles can have sizes that range from about 10 nm to about 30 nm.

The magnetic particles of the present disclosure may also have various Curie temperatures. The Curie temperature (Tc) (or Curie point) is the temperature at which a ferromagnetic or a ferrimagnetic material becomes paramagnetic on heating. The effect is generally reversible. However, a magnet may lose its magnetism if heated above the Curie temperature. In some embodiments, the magnetic particles of the present disclosure may have a Curie temperature between about 30° C. and about 150° C. In some embodiments, the magnetic particles of the present disclosure may have a Curie temperature of more than about 125° C.

For many magnetic materials, such as magnetic particles, higher Curie temperatures provide more constant magnetic susceptibilities at temperatures that resemble downhole conditions. Thus, in some embodiments, it may be desirable to choose magnetic particles with the highest Curie temperature and the highest magnetic susceptibility such that the highest signal to noise may be obtained. For example, many magnetic particles may have a room temperature magnetic susceptibility of about 40,700×10⁻⁸ m³kg⁻¹ that is decreased significantly at 125° C. In contrast, magnetic particles of the composition Mn_{0.5}Zn_{0.5}Fe₂O₄ ferrite only have a room temperature magnetic susceptibility of 16,440×10⁻⁸ m³kg⁻¹ that remains unchanged at 125° C. Thus, the use of magnetic particles of the composition Mn_{0.5}Zn_{0.5}Fe₂O₄ ferrite may be preferred for downhole applications in some embodiments.

In various embodiments, the magnetic particles of the present disclosure may include ferromagnetic or ferrimagnetic particles. In some embodiments, the magnetic particles of the present disclosure can include paramagnetic or superparamagnetic particles.

Various methods may also be used to make magnetic particles. For instance, a wide range of syntheses of magnetite (iron oxide) are known. See, e.g., C. A. Crouse and A. R. Barron, J. Mater. Chem., 2008, 18, 4146. Many of these synthetic approaches can be used for mixed metal oxide particles described above. Such syntheses can result in metal oxide particles that are surface stabilized or functionalized with a molecular group, often based upon a carboxylic acid, that allow for their miscibility or solubility in a desired medium. In some embodiments, starting materials (e.g., iron acetylacetonate and cobalt acetylacetonate) are combined with a specific starting ratio (e.g., ratios given in millimoles (mmol)). To this is added, also in predetermined ratios, oleic acid, oleylamine, 1,2-hexadecanediol and benzyl ether. The oleic acid and oleylamine act as surfactants. The 1,2-hexadecanediol is used to either promote nucleation or limit growth, allowing for small particles that are monodisperse to be formed. In some embodiments, benzyl ether can be used as the solvent. After the reaction is run and the particles are cleaned and suspended in hexanes, analysis can be performed in order to obtain the ratio of iron to the other metal in the particles. Such modes of nanoparticle synthesis are described in more detail in the Examples herein. Though such methods are known, there has been no previous attempt to determine a correlation between starting ratios and end product ratios in order to control the properties of magnetic particles.

Methods of Detecting Fracture Fluid Contamination

As illustrated in FIG. 1, further embodiments of the present disclosure pertain to methods of detecting a contamination of an environment by a fracture fluid that contains magnetic particles. In some embodiments, such methods include: (1) collecting a sample from the environment that is suspected of being contaminated by a fracture fluid; and (2) measuring a magnetic susceptibility of the sample in order to detect the presence or absence of magnetic particles. In such embodiments, the presence of the magnetic particles can indicate the presence of the fracture fluid in the environment. In further embodiments, the Curie temperature of the magnetic particles in the sample may also be measured in order to detect the presence or absence of the magnetic particles in the samples.

As set forth in more detail herein, various aspects of the aforementioned embodiments can be used to measure the magnetic susceptibility of a sample in order to specifically detect the presence of particular magnetic particles within a fracture fluid, even in the presence of other magnetic particles or minerals. Furthermore, the fracture fluids to be detected may be associated with various magnetic particles, as previously described. In addition, the methods of the present disclosure may be used to detect fracture fluids from various environments. In addition, various methods may be utilized to collect samples from an environment and measure the magnetic susceptibility of the sample. Likewise, various methods may be utilized to specifically identify a fracture fluid in an environment.

Environments

Fracture fluids may be detected from various environments. In some embodiments, the environment may include at least one of mineral formations, landfills, water sources, soils, rock formations, and combinations thereof. In more specific embodiments, the methods of the present disclosure may be used to detect fracture fluids from one or more water sources, such as production water, ground water, river water, drinking water, flood water, or combinations thereof. In more specific embodiments, the environment may be a ground water source. In further embodiments, the environment may be a water source at a well site, a water source remote from a well site, or a water source suspected of being contaminated by fracture fluids.

Sample Collection from an Environment

Various methods may also be used to collect samples from an environment. In some embodiments, samples may be collected by methods that include at least one of extraction, pipetting, pumping, purging, and combinations thereof. Additional methods of sample collection can also be envisioned.

Sample Processing

In some embodiments, the magnetic susceptibility of collected samples may be measured directly without any further processing of the sample. In some embodiments, the sample may be processed by various methods prior to a magnetic susceptibility measuring step. For instance, in some embodiments, the sample may be concentrated before the measuring step. In some embodiments, the magnetic particles in the sample may be separated from the sample before the measuring step. In some embodiments, the magnetic particles may be separated from the sample by magnetic separation. In further embodiments, the sample may be concentrated and the magnetic particles from the sample may be separated prior to the magnetic susceptibility measuring step.

Magnetic Susceptibility Measurements

Magnetic susceptibility generally refers to the magnetization divided by the applied field. Various methods may be used to measure the magnetic susceptibility of a sample. For instance, in some embodiments, the magnetic susceptibility of a sample can be measured by utilizing standard susceptibility bridges (e.g., low applied field devices), or by determining hysteresis curves (e.g., using variable field translation balance) where the slope at each point on the curve is the magnetic susceptibility at that point. The advantage of the latter technique is that the magnetic susceptibility over a range of low and high applied fields can be determined.

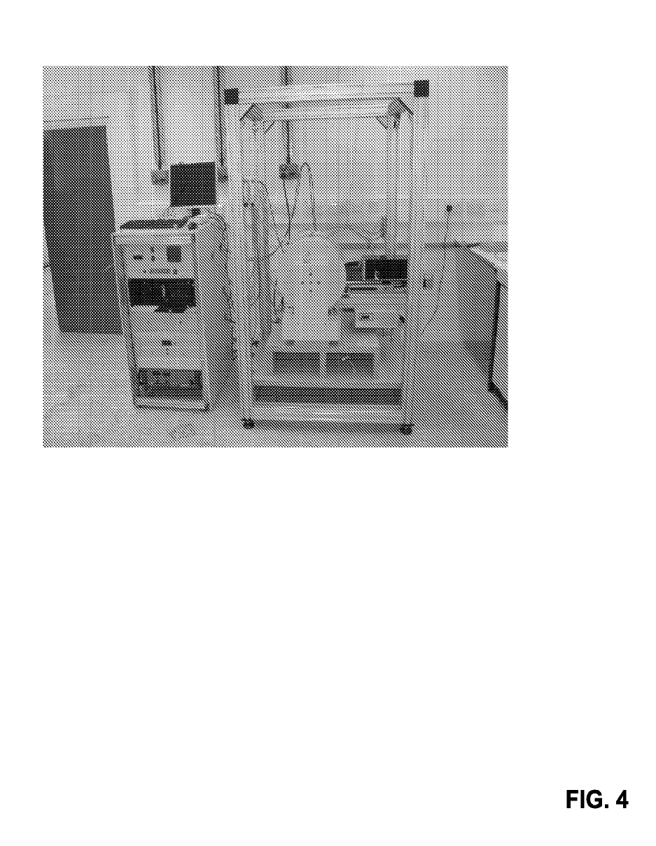

In more specific embodiments, the magnetic susceptibility of a sample is measured by a variable field translation balance (VFTB). An example of a VFTB is shown in FIG. 4. In some embodiments, the magnetic susceptibility of the sample is measured in a temperature dependent manner. In some embodiments, the magnetic susceptibility of a sample is measured at or below the Curie temperature of the magnetic particles in the sample.

Identification of Source of Fracture Fluid

In some embodiments, the measured magnetic susceptibility of a sample can be used to identify the source of a contaminating fracturing fluid in an environment. For instance, in some embodiments, the source of a contaminating fracturing fluid is identified by comparing a magnetic hysteresis curve of the sample with one or more magnetic hysteresis curves that correspond to one or more known magnetic particles. In some embodiments, the raw magnetic hysteresis curves could be used for comparative purposes. In some embodiments, the slope of the magnetic hysteresis curves at each point (i.e., the magnetic susceptibility) could be used for comparative purposes.

In further embodiments, temperature dependent magnetic susceptibility can be used to uniquely characterize a particular magnetic particle. For instance, in some embodiments, the temperature dependence of the low field magnetic susceptibility of a magnetic particle can be used to uniquely characterize a particular magnetic particle. In some embodiments, the variable field or low field magnetic susceptibility can be measured at a series of temperatures that are characteristic of a particular magnetic particle. The temperature dependence of the magnetic susceptibility can then be plotted as a function of temperature. In such embodiments, the characteristic temperature-dependent variation of magnetic susceptibility can provide a fingerprint for a particular magnetic particle.

In some embodiments, the temperature dependence of magnetic hysteresis curves could also be used to uniquely characterize a magnetic particle, such as over a range of low and high applied magnetic fields. In various embodiments, the raw magnetic hysteresis curves as a function of temperature could be used, or the slope of the hysteresis curves as a function of temperature at each point (i.e., the magnetic susceptibility) could be used.

In further embodiments, measured Curie temperatures can be used to uniquely characterize particular magnetic particles. For instance, in some embodiments, the Curie temperature of a sample or magnetic particles from the sample can be compared to the Curie temperatures of known magnetic particles in order to identify the unknown magnetic particles. In some embodiments, such Curie temperature measurements can be used in combination with magnetic susceptibility measurements in order to identify the source of the magnetic particles. In some embodiments, the Curie temperature measurements can be used alone to identify the source of the magnetic particles.

Methods of Tracing Fracture Fluids in Mineral Formations

As illustrated in FIG. 2, additional embodiments of the present disclosure pertain to methods of tracing fracture fluids in mineral formations. In some embodiments, such methods include: (1) associating the fracture fluids with magnetic particles; (2) introducing the fracture fluids into the mineral formation; and (3) measuring a magnetic susceptibility of the magnetic particles in the fracture fluids. In further embodiments, the methods may also include a step of measuring the Curie temperatures of the magnetic particles in the fracture fluids. As set forth in more detail herein, such methods may utilize various magnetic particles to trace various fracture fluids in various mineral formations.

Fracture Fluids

Fracture fluids generally refer to fluids that are utilized in hydraulic fracturing. In some embodiments, the fracture fluids may include at least one of water (e.g., production water or flood water), proppant, brine, drilling fluid, drilling mud, hydrocarbons, hydraulic fluids, and combinations thereof. In some embodiments, the fracture fluids comprise proppant. In some embodiments, the fracture fluids may include water, such as flood water or production water.

Associating Fracture Fluids with Magnetic Particles

Various methods may also be used to associate fracture fluids with magnetic particles. In some embodiments, the associating may include mixing the magnetic particles with the fracture fluids. In some embodiments, the associating may occur before introducing the fracture fluids into a mineral formation. In other embodiments, the associating may occur after introducing the fracture fluids into the mineral formation. In more specific embodiments, magnetic particles may be associated with fracture fluids during a hydraulic fracture stage, a water flood, or other downhole processes.

Magnetic Particles

In addition, various magnetic particles may be associated with fracture fluids. Suitable magnetic particles that could be associated with fracture fluids were disclosed previously. In more specific embodiments, suitable magnetic particles may include the following formula: MₓM′_{y}Fe₂O₄. In some embodiments, x+y=1. In some embodiments, M and M′ are each selected from the group consisting of zinc, manganese, cobalt, copper, vanadium, and combinations thereof. In some embodiments, the molar ratio of x to y is at least one of 0.5:0.5, 0.35:0.65, 0.65:0.35, 0.4:0.6, 0.6:0.4, 0.1:0.90, or 0.9:0.1.

In further embodiments, suitable magnetic particles for use in fracture fluids may include the following formula: MnₓZn_{y}Fe₂O₄. In some embodiments, x+y=1. In some embodiments, the molar ratio of x to y is at least one of 0.5:0.5, 0.35:0.65, 0.65:0.35, 0.4:0.6, 0.6:0.4, 0.1:0.90, or 0.9:0.1. In more specific embodiments, magnetic particles for use in fracture fluids may include Mn_{0.5}Zn_{0.5}Fe₂O₄.

Introducing the Fracture Fluids into a Mineral Formation

Various methods may also be used to introduce fracture fluids into mineral formations. In some embodiments, the introducing may include pumping the fracture fluids into a mineral formation. In some embodiments, the introducing may include pouring or injecting the fracture fluids into a mineral formation. Additional methods of introducing fracture fluids into mineral formations can also be envisioned.

Mineral Formations

Furthermore, the fracture fluids of the present disclosure can be introduced into various mineral formations. For instance, in some embodiments, the mineral formation may include a reservoir. In some embodiments, the reservoir may include a borehole. In some embodiments, the reservoir comprises an oil and gas well. In some embodiments, the reservoir may include a subterranean reservoir containing a hydrocarbon, such as natural gas or oil. In some embodiments, the mineral formation may be a reservoir after a hydraulic fracture had been performed on the reservoir.

Measuring Magnetic Susceptibility

Various methods may also be used to measure the magnetic susceptibility of the fracture fluids. Such methods were previously described. In some embodiments, the measuring can occur while the fracture fluids are in a mineral formation. In some embodiments, the measuring can occur after a sample of the fracture fluids is collected. In some embodiments, the sample is concentrated before the measuring step. In some embodiments, the magnetic particles are separated from the sample before the measuring step, such as by magnetic separation. In some embodiments, the measuring may occur in a temperature dependent manner. In some embodiments, the measuring step may occur while the fluids flow out of or escape from the mineral formation.

In more specific embodiments, the methods of the present disclosure may be used in a water flood. In some embodiments, magnetic particles may be injected with the water during the water flood. Subsequently, the magnetic particle is concentrated and separated from water received at a number of production wells. In such embodiments, the time delay between injection and recovery can provide information on the path of the water. Furthermore, the detection of the magnetic particle at a particular production well, one from which oil is produced, can indicate connectivity with the injection well.

Computer Programs

Additional embodiments of the present disclosure pertain to computer programs, preferably on a data carrier or computer readable medium. In some embodiments, the computer program may have code or instructions for receiving or accessing the measured magnetic susceptibility of a sample, and determining a value of the parameter using that measured susceptibility. Preferably, the computer program has code or instructions for receiving the identity of at least two components of the sample; identifying the magnetic susceptibility of the two identified components; and using the measured magnetic susceptibility and susceptibilities of the two identified components to determine the fraction of the total sample contributed by at least one of the components, wherein the code or instructions for determining the value of the parameter are operable to use the determined fraction to determine the value of the parameter. In some embodiments, by knowing two identified components (for example, two types of magnetic particles of different composition) the program can be used to determine the fraction of each component in the sample.

Applications and Advantages

The methods, magnetic particles and fracture fluids of the present disclosure provide numerous applications and advantages. For instance, unlike existing isotope tracers, the magnetic particles of the present disclosure are durable, long-lived and non-toxic. Furthermore, the number of unique magnetic tracer fingerprint particles that can be made is large and not as limited as the isotope tracers.

In addition, since the magnetic particles of the present disclosure can be detected downhole, the magnetic particles can be used to create an image log of the magnetic particle distributions. Such applications exceed the capabilities of existing isotope and chemical tracers. Furthermore, the detection and separation of the magnetic particles of the present disclosure can be done either downhole or on the surface, thereby enabling real-time decision-making on the wellsite.

Moreover, various aspects of the present disclosure provide for hydraulic fracturing, fluid tracing and detection processes that are of use to unconventional energy exploration companies with the intent of providing a fingerprint of their fracture fluids to ensure environmental and legislative compliance. Various aspects of the present disclosure may also be used by environmental, government, or individuals attempting to determine if fracing has caused any environmental impact. Furthermore, the present disclosure provides a reliable and safe method to track the long-term flow of fracture fluids to ensure a sustainable future for hydraulic fracturing. The present disclosure also offers a stable, non-invasive, non-toxic tracer and tracer detection service that provides the capability to detect, differentiate, and identify fracture fluids pumped down-hole, even if those fluids are collected from remote locations many months later.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Synthesis of Magnetic Particles

Table 1 summarizes the starting ratios of iron to metal used in the experiments. The steps for the reaction are as follows: Weigh or measure out each chemical and add it to a three-neck round bottom flask. Add 37.5 mL of benzyl ether. Heat the reaction solution to 200° C. at 10° C.·min⁻¹. Let sit at 200° C. for 15 min and then reflux at 270° C. for several hours and then allow it to cool to room temperature. Work up of the reaction consisted of precipitation of the reaction solution with ethanol. This was followed by centrifugation at 4,400 rpm for 30 minutes, with a slow deceleration. The supernatant was then decanted and discarded. Next, the precipitate was washed again with ethanol. The supernatant was discarded and the samples were air dried overnight.

Once samples were dry, they were suspended in hexanes. The samples were then centrifuged once more to remove aggregates. The supernatant was saved, as this was the sample. Samples were prepared for small-angle X-ray scattering (SAXS) by having it suspended in hexanes and being super-concentrated. Samples were prepared for atomic force microscopy (AFM) by spin coating onto mica. Samples were prepared for inductively coupled plasma-mass spectroscopy (ICP-MS) by digesting 500 micro liters (μL) of the sample in 9.5 mL concentrated nitric acid in a 15 mL centrifuge tube. The samples sat for two days with a loose cap inside a fume hood. From this, 0.5 mL was taken and added to 9.5 mL of HPLC-grade water. A summary of synthetic ratios is given in Table 1.

TABLE 1
Summary of Ratios of Starting Products used to make magnetic particles.

| Fe(acac)₃ | Mn(acac)₂ | Zn(acac)₂ | 1,2-hexadecane- | Oleic acid | Oleylamin | Starting |
|---|---|---|---|---|---|---|
| (mmol) | (mmol) | (mmol) | diol (mmol) | (mmol) | (mmol) | Mn:Zn |
| 1.330 | 0.330 | 0.330 | 10.000 | 6.000 | 6.000 | 0.5:0.5 |
| 1.330 | 0.231 | 0.429 | 10.000 | 6.000 | 6.000 | 0.35:0.65 |
| 1.330 | 0.429 | 0.231 | 10.000 | 6.000 | 6.000 | 0.65:0.35 |
| 1.330 | 0.218 | 0.436 | 10.000 | 6.000 | 6.000 | 0.33:0.66 |
| 1.330 | 0.436 | 0.218 | 10.000 | 6.000 | 6.000 | 0.66:0.33 |
| 1.330 | 0.066 | 0.594 | 10.000 | 6.000 | 6.000 | 0.1:0.9 |
| 1.330 | 0.594 | 0.066 | 10.000 | 6.000 | 6.000 | 0.9:0.1 |

### Example 2

### Magnetic Susceptibility Measurements of Magnetic Particles

Next, low field magnetic susceptibility measurements were made using standard magnetic susceptibility bridges on the magnetic particles from Example 1, and also on typical reservoir rocks and fluids. Magnetic hysteresis curves were obtained for the magnetic particles using a variable field translation balance (VFTB). The VFTB used is shown in FIG. 4. This type of VFTB used an electromagnet (rather than a solenoid) in order to generate higher fields. The VFTB provides a method of estimating the magnetic susceptibility at a range of low and high fields (up to about 1 Tesla). The slope of the hysteresis curve at any point (magnetization/applied field) is the magnetic susceptibility at that point. The magnetic hysteresis curves were determined not only at room temperature, but also at higher temperatures in order to simulate downhole reservoir temperatures. The magnetic particles were mixed with calcium fluoride powder. This mixture was then poured into the sample containers in order to do the measurements. The calcium fluoride powder provides a good medium in which to disperse the particles to minimize interactions between the magnetic particles, and also provides an inert matrix for the temperature measurements. The VFTB is also capable of doing low temperature magnetic measurements, if necessary.

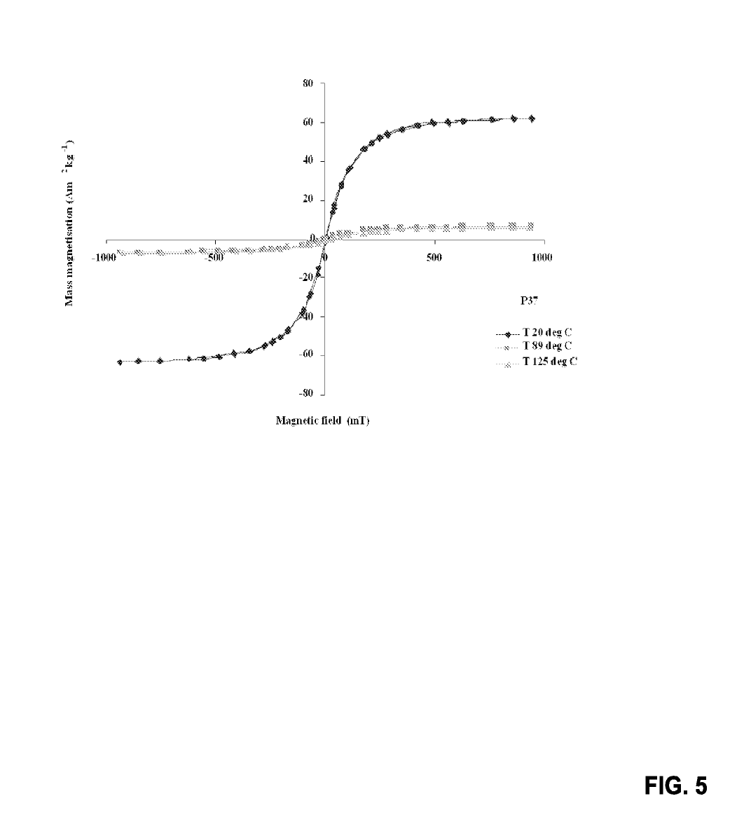

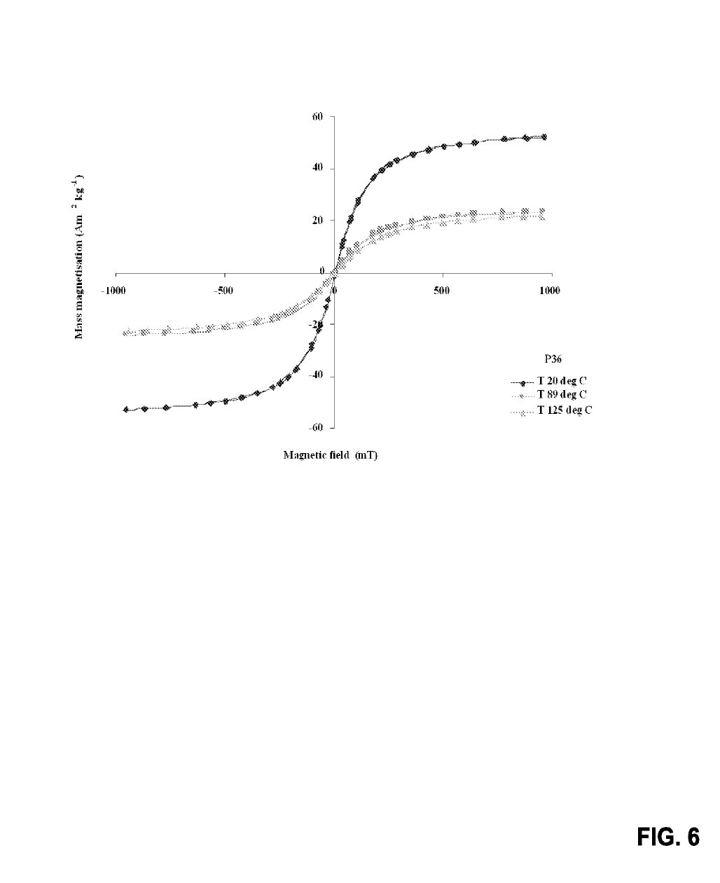

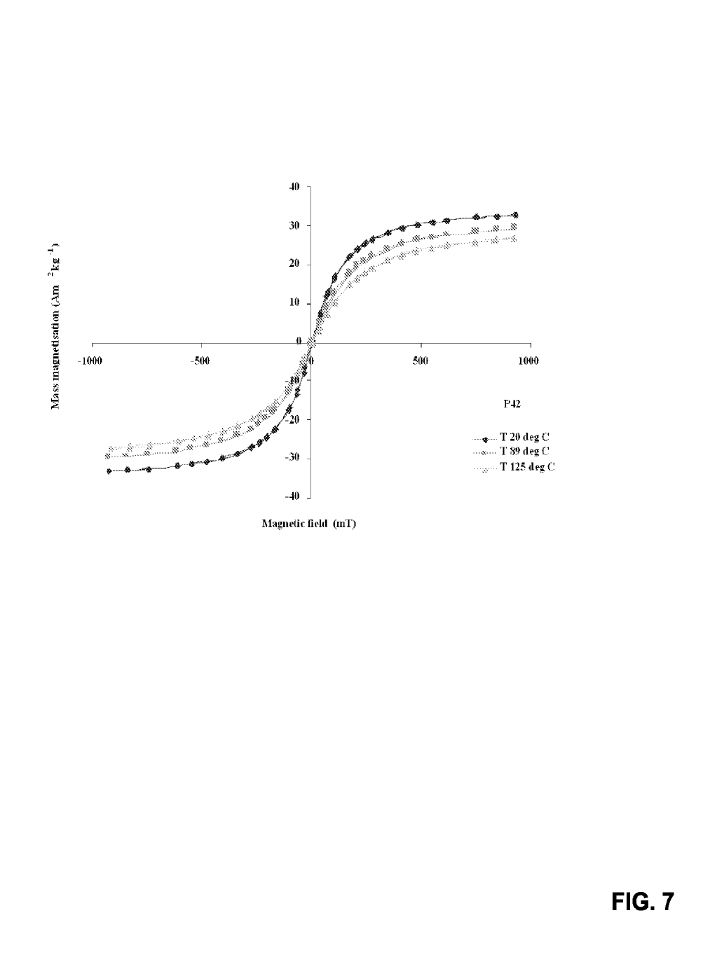

The hysteresis curves are shown in FIGS. 5-7. The results of the magnetic susceptibility measurements are summarized in Table 2.

TABLE 2
Magnetic field susceptibility measurements of various
magnetic particles.

| | Spinel ferrite | Room temperature low field mass |
|---|---|---|
| Particle Sample | Mn:Zn ratio | magnetic susceptibility (10⁻⁸ m³kg⁻¹) |
| P36 | 60:40 | 40,700 |
| P37 | 40:60 | 36,580 |
| P42 | 50:50 | 16,440 |

The potential suitability of magnetic particles for downhole (reservoir temperature) applications can depend on the Curie point of the particles. The higher the Curie point, the more suitable the sample, since the magnetization and the magnetic susceptibility is not likely to decrease as much under reservoir conditions. Therefore, mass magnetization versus temperature determinations (which can also be done on the VFTB) can be an important aspect.

In addition, an experimental system has been developed to allow one to measure the low field magnetic susceptibility of simulated borehole samples. This can allow the necessary concentration of the magnetic particles that can be detected once mixed with the proppant. The system also allows one to test the sensitivity of a prototype downhole low field magnetic susceptibility device.

### Example 3

### Synthesis of 20 Nanometer Iron-Metal Magnetic Particles

This Example provides methods of synthesizing 20 nm iron-metal magnetic particles. The starting materials are desirably added with known starting ratios. The iron to metal ratio may be selected at will. The iron source is iron (III) acetylacetonate. The two other metal sources are magnesium (II) acetylacetonate and zinc (II) acetylacetonate. The oleic acid:oleylamine:1,2-hexadecandiol are used in a molar ratio of 2:2:1, respectively. With the ratios listed, 37.5 milliliters of a low-boiling point organic solvent, such as benzyl ether, is added. There are two methods to make larger sized particles (20 nm). Method 2 requires the addition of chemicals halfway through the reaction. In the step designated in method 2 below, 2 mmol iron (III) acetylacetonate, 10 mmol 1-octadecanol, 2 mmol oleic acid, and 2 mmol oleylamine are added. The two methods are described below.

Method 1

All starting chemicals are calculated in grams or milliliters from their specified starting ratios. Weigh out or measure each chemical required and add it to a 3-necked round bottom flask (100 milliliters). Add 37.5 milliliters of benzyl ether. Add a stir bar. Set up a reflux condenser on a schlenk line. A variac, heating mantel, and a stir plate are utilized. To the schlenk line, attach an inert gas source and a bubbler in order to maintain an atmosphere of inert gas while running the experiment. To the reflux condenser set up, attach the 100 mL three-neck round bottom flask with the reflux condenser in the middle neck. To one of the side necks, add a mercury thermometer with thermometer adapter to create a seal. To the other side neck, add a glass stopper, creating a seal. Turn on the water for the reflux condenser. Turn on the inert gas, opening the valves correctly. Remove the glass stopper so air is flushed out of the system. After a minute, reinsert the glass stopper. Turn on the stir bar while making sure the thermometer is not being hit by the stir bar. Turn on the variac. Heat the solution to 200° C. at a rate of 10° C./minute. Once solution has reached 200° C., hold the temperature for four (4) hours. After four (4) hours have passed, increase the temperature to reflux (270° C. for benzyl ether) at the same rate of 10° C./minute. Once the reflux temperature has been reached, hold the temperature for one (1) hour. Once one (1) has passed, turn the variac off and let the solution cool to room temperature. Remove the flask from the reflux condenser. Add to the flask 40 milliliters of ethanol to stop the reaction and precipitate out the particles. Split the sample evenly into two (2) 50-milliliter centrifuge tubes, weighing and adding more ethanol to make sure the centrifuge tubes are even. Centrifuge the centrifuge tubes at 4400 rpm for 30 minutes, using slow deceleration. Once done centrifuging, remove the supernatant via decanting and discard supernatant. Add 15 milliliters of ethanol to each centrifuge tube. Centrifuge the samples at 4400 rpm for 15 minutes, using slow deceleration. Remove supernatant via decanting and discard supernatant. Let samples air dry in centrifuge tube overnight. Once samples are dry, suspend in hexanes. Centrifuge samples at 4400 rpm for 30 minutes, with slow deceleration. Remove supernatant via decanting and save supernatant in 20 milliliter scintillation vials.

Method 2

All starting chemicals are calculated in grams or milliliters from their specified starting ratios. Weigh out or measure each chemical required and add it to a 3-necked round bottom flask (100 milliliters). Add 37.5 milliliters of benzyl ether. Add a stir bar. Set up a reflux condenser on a schlenk line. A variac, heating mantel, and a stir plate are required. To the schlenk line, attach an inert gas source and a bubbler in order to maintain an atmosphere of inert gas while running the experiment. To the reflux condenser set up, attach the 100 mL three-neck round bottom flask with the reflux condenser in the middle neck. To one of the side necks, add a mercury thermometer with thermometer adapter to create a seal. To the other side neck, add a glass stopper, creating a seal. Turn on the water for the reflux condenser. Turn on the inert gas, opening the valves correctly. Remove the glass stopper so air is flushed out of the system. After a minute, reinsert the glass stopper. Turn on the stir bar while making sure the thermometer is not being hit by the stir bar. Turn on the variac. Heat the solution to 200° C. at a rate of 10° C./minute. Once solution has reached 200° C., hold the temperature for two (2) hours. After two (2) hours have passed, increase the temperature to reflux (270° C. for benzyl ether) at the same rate of 10° C./minute. Once the reflux temperature has been reached, hold the temperature for one (1) hour. After one (1) hour has passed, reduce temperature to 230° C. and add the excess starting material. Hold the temperature after adding the excess material at 230° C. for one (1) hour. Once one (1) has passed, turn the variac off and let the solution cool to room temperature. Remove the flask from the reflux condenser. Add to the flask 40 milliliters of ethanol to stop the reaction and precipitate out the particles. Split the sample evenly into two (2) 50-milliliter centrifuge tubes, weighing and adding more ethanol to make sure the centrifuge tubes are even. Centrifuge the centrifuge tubes at 4400 rpm for 30 minutes, using slow deceleration. Once done centrifuging, remove the supernatant via decanting and discard supernatant. Add 15 milliliters of ethanol to each centrifuge tube. Centrifuge the samples at 4400 rpm for 15 minutes, using slow deceleration. Remove supernatant via decanting and discard supernatant. Let samples air dry in centrifuge tube overnight. Once samples are dry, suspend in hexanes. Centrifuge samples at 4400 rpm for 30 minutes, with slow deceleration. Remove supernatant via decanting and save supernatant in 20 milliliter scintillation vials.

### Example 4

### Filtering and Concentrating 20 Nanometer Nanoparticles

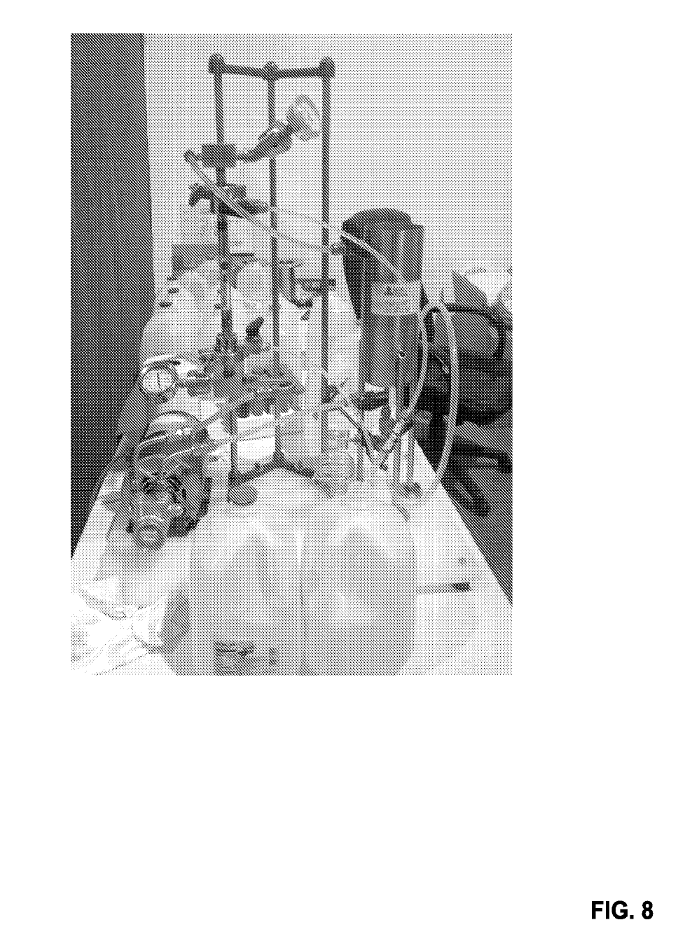

This Example outlines the filtering and concentration of 20 nm FeMnZn nanoparticles. The solutions used in the filtering system were 0.025 wt %, 0.0025 wt %, and 0.00025 wt % 20 nanometer FeMnZn nanoparticles in store-bought distilled water. The filtration system used was bench-top scaled version of the Molecular Filtration unit, pictured in FIG. 8. Three filters with different pore sizes were used: 0.14 micrometers, 300 kilodaltons, and 8 kilodaltons.

In operation, the filtration system was thoroughly scrubbed and flushed with distilled water to remove any residues from previous experiments. The 0.025 wt % solution was run first, through the 0.14 micrometer filter. The concentrate was collected in a container and 50 milliliters was set aside in a 50 milliliter centrifuge tube. The permeate was collected in a different container. The system was flushed with half a gallon of distilled water twice. Next, the 0.0025 wt % solution was run through the 0.14 micrometer filter. The concentrate was collected in a container and 50 milliliters was set aside in a 50 milliliter centrifuge tube. The permeate was collected in a different container. The system was again flushed with half a gallon of distilled water, twice. Finally, the 0.0025 wt % solution was passed through the 0.14 micrometer filter. The concentrate was collected and 50 milliliters was set aside in a 50 milliliter centrifuge tube.

Next, the filter was changed from the 0.14 micrometer filter to the 300 kilodalton filter. The system was flushed with half a gallon of distilled water, twice, to remove any residue from the previous filtrations and to clean the new filter. The 0.025 wt % permeate that had been collected was then passed through the 300 kilodalton filter. The concentrate was collected in a container and 50 milliliters was set aside in a 50 milliliter centrifuge tube. The permeate was collected in a separate container. The system was flushed with half a gallon of distilled water twice. Then, the 0.0025 wt % permeate was run through the 300 kilodalton filter. The concentrate was collected in a container and 50 milliliters was set aside in a 50 milliliter centrifuge tube. The permeate was collected in a different container. Again, the system was flushed with half a gallon of distilled water, twice. Finally, the 0.00025 wt % permeate was passed through the 300 kilodalton filter. The concentrate was collected in a container and 50 milliliters was set aside in a 50 milliliter centrifuge tube. The permeate was collected in a separate container.

Next, the filter was changed from the 300 kilodalton filter to the 8 kilodalton filter. The system was flushed with half a gallon of distilled water, twice, to remove any residue from previous filtrations. The 0.025 wt % permeate that had been collected from the 300 kilodalton filter was then passed through the 8 kilodalton filter. The concentrate was collected in a container and 50 milliliters was set aside in a 50 milliliter centrifuge tube. The permeate was collected in a separate container. The system was flushed with half a gallon of distilled water, twice. Then, the 0.0025 wt % permeate was run through the 8 kilodalton filter. The concentrate was collected in a container and 50 milliliters was set aside in a 50 milliliter centrifuge tube. The permeate was collected in a different container. The system was once again flushed with half a gallon of distilled water, twice. Finally, the 0.00025 wt % permeate was passed through the 8 kilodalton filter. The concentrate was collected in a container and 50 milliliters was set aside in a 50 milliliter centrifuge tube. The permeate was collected in a separate container. Half a gallon of distilled water was run through the system in two separate occasions to clean out the filter and leave it prepped for any following experiments.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of detecting a contamination of an environment by a fracture fluid,
wherein the fracture fluid comprises magnetic particles, and wherein the method comprises:
collecting a sample from the environment; and
measuring a magnetic susceptibility of the sample in order to detect the presence or absence of the magnetic particles,
wherein the presence of the magnetic particles indicates the presence of the fracture fluid in the environment.

2. The method of claim 1, wherein the magnetic susceptibility of the sample is measured by a variable field translation balance (VFTB).

3. The method of claim 1, wherein the magnetic susceptibility of the sample is used to identify the source of the contaminating fracturing fluid.

4. The method of claim 3, wherein the source of the contaminating fracturing fluid is identified by comparing a magnetic hysteresis curve of the sample with magnetic hysteresis curves of known magnetic particles.

5. The method of claim 1, wherein the environment comprises at least one of a mineral formation, landfill, water source, soil, rock formations, and combinations thereof.

6. The method of claim 1, wherein the sample is concentrated before the measuring step.

7. The method of claim 1, wherein the magnetic particles are separated from the sample before the measuring step.

8. The method of claim 1, wherein the magnetic particles comprise MₓM′_{y}Fe₂O₄,
wherein x+y=1, and
wherein M and M′ are each selected from the group consisting of zinc, manganese, cobalt, copper, vanadium, and combinations thereof.

9. The method of claim 8, wherein the molar ratio of x to y is at least one of 0.5:0.5, 0.35:0.65, 0.65:0.35, 0.4:0.6, 0.6:0.4, 0.1:0.90, or 0.9:0.1.

10. The method of claim 1, wherein the magnetic particles comprise MnₓZn_{y}Fe₂O₄, wherein x+y=1.

11. The method of claim 10, wherein the molar ratio of x to y is at least one of 0.5:0.5, 0.35:0.65, 0.65:0.35, 0.4:0.6, 0.6:0.4, 0.1:0.90, or 0.9:0.1.

12. The method of claim 1, wherein the magnetic particles comprise Mn_{0.5}Zn_{0.5}Fe₂O₄.

13. The method of claim 1, wherein the magnetic particles exclude Fe₃O₄.

14. The method of claim 1, wherein the magnetic particles comprise superparamagnetic particles.

15. The method of claim 1, wherein the magnetic particles are functionalized.

16. The method of claim 15, wherein the functional groups are selected from the group consisting of carboxyl groups, sulfur groups, amine groups, hydroxyl groups, and combinations thereof.

17. The method of claim 1, wherein the magnetic particles have a Curie temperature of more than about 125° C.

18. The method of claim 1, wherein the magnetic particles have a size between about 0.5 nm and about 200 nm.

19. The method of claim 1, wherein the magnetic particles have a size between about 10 nm and about 30 nm.

20. The method of claim 1, wherein the magnetic susceptibility is measured at or below the Curie temperature of the magnetic particles.

21. The method of claim 1, further comprising a step of measuring the Curie temperature of the magnetic particles in the sample.

22. A method of tracing fracture fluids in a mineral formation, wherein the method comprises:
associating the fracture fluids with magnetic particles,
wherein the magnetic particles comprise MₓM′_{y}Fe₂O₄,
wherein x+y=1, and
wherein M and M′ are each selected from the group consisting of zinc, manganese, cobalt, copper, vanadium, and combinations thereof;
introducing the fracture fluids into the mineral formation; and
measuring a magnetic susceptibility of the magnetic particles in the fracture fluids.

23. The method of claim 22, wherein the associating comprises mixing the magnetic particles with the fracture fluids.

24. The method of claim 22, wherein the associating occurs before introducing the fracture fluids into the mineral formation.

25. The method of claim 22, wherein the associating occurs after introducing the fracture fluids into the mineral formation.

26. The method of claim 22, wherein the molar ratio of x to y is at least one of 0.5:0.5, 0.35:0.65, 0.65:0.35, 0.4:0.6, 0.6:0.4, 0.1:0.90, or 0.9:0.1.

27. The method of claim 22, wherein the magnetic particles comprise MnₓZn_{y}Fe₂O₄, wherein x+y=1.

28. The method of claim 27, wherein the molar ratio of x to y is at least one of 0.5:0.5, 0.35:0.65, 0.65:0.35, 0.4:0.6, 0.6:0.4, 0.1:0.90, or 0.9:0.1.

29. The method of claim 22, wherein the magnetic particles comprise Mn_{0.5}Zn_{0.5}Fe₂O₄.

30. The method of claim 22, wherein the introducing comprises pumping the fracture fluids into the mineral formation.

31. The method of claim 22, wherein the measuring occurs while the fracture fluids are in the mineral formation.

32. The method of claim 22, wherein the measuring occurs after a sample of the fracture fluids is collected.

33. The method of claim 32, wherein the sample is concentrated before the measuring step.

34. The method of claim 32, wherein the magnetic particles are separated from the sample before the measuring step.

35. The method of claim 22, wherein the measuring occurs while the fracture fluids flow out or escape from the mineral formation.

36. The method of claim 22, wherein the mineral formation comprises a reservoir.

37. The method of claim 36, wherein the reservoir comprises a borehole.

38. The method of claim 22, wherein the fracture fluids comprise at least one of water, proppant, brine, drilling fluid, drilling mud, hydrocarbons, hydraulic fluids, and combinations thereof.

39. The method of claim 22, wherein the fracture fluids comprise at least one of production water or flood water.

40. The method of claim 22, further comprising a step of measuring the Curie temperature of the magnetic particles in the fracture fluid.

41. A fracture fluid comprising magnetic particles,
wherein the magnetic particles comprise MₓM′_{y}Fe₂O₄,
wherein x+y=1, and
wherein M and M′ are each selected from the group consisting of zinc, manganese, cobalt, copper, vanadium, and combinations thereof.

42. The fracture fluid of claim 41, wherein the molar ratio of x to y is at least one of 0.5:0.5, 0.35:0.65, 0.65:0.35, 0.4:0.6, 0.6:0.4, 0.1:0.90, or 0.9:0.1.

43. The fracture fluid of claim 41, wherein the magnetic particles comprise MnₓZn_{y}Fe₂O₄, wherein x+y=1.

44. The fracture fluid of claim 43, wherein the molar ratio of x to y is at least one of 0.5:0.5, 0.35:0.65, 0.65:0.35, 0.4:0.6, 0.6:0.4, 0.1:0.90, or 0.9:0.1.

45. The fracture fluid of claim 41, wherein the magnetic particles comprise Mn_{0.5}Zn_{0.5}Fe₂O₄.

46. The fracture fluid of claim 41, wherein the magnetic particles exclude Fe₃O₄.

47. The fracture fluid of claim 41, wherein the fracture fluids comprise at least one of water, proppant, brine, drilling fluid, drilling mud, hydrocarbons, hydraulic fluids, and combinations thereof.

48. The fracture fluid of claim 41, wherein the fracture fluids comprise at least one of production water or flood water.

49. A magnetic particle comprising:
MₓM′_{y}Fe₂O₄,
wherein x+y=1; and
wherein M and M′ are each selected from the group consisting of zinc, manganese, cobalt, copper, vanadium, and combinations thereof.

50. The magnetic particle of claim 49, wherein the molar ratio of x to y is at least one of 0.5:0.5, 0.35:0.65, 0.65:0.35, 0.4:0.6, 0.6:0.4, 0.1:0.90, or 0.9:0.1.

51. The magnetic particle of claim 49, wherein the magnetic particles comprise MnₓZn_{y}Fe₂O₄, wherein x+y=1.

52. The magnetic particle of claim 51, wherein the molar ratio of x to y is at least one of 0.5:0.5, 0.35:0.65, 0.65:0.35, 0.4:0.6, 0.6:0.4, 0.1:0.90, or 0.9:0.1.

53. The magnetic particle of claim 49, wherein the magnetic particles comprise Mn_{0.5}Zn_{0.5}Fe₂O₄.

54. The magnetic particle of claim 49, wherein the magnetic particles exclude Fe₃O₄.
